(19) United States
(12) Patent Application Publication
(10) Pub. No.: US 2009/0116796 A1
(43) Pub. Date: May 7, 2009

(54) Optical cable and method for the production of an optical cable

(76) Inventors: Andreas Stingl, Bayreuth (DE); Waldemar Stocklein, Coburg (DE); Gunter Wunsch, Coburg (DE)

Correspondence Address: CORNING INCORPORATED, INTELLECTUAL PROPERTY DEPARTMENT, SP-TI-3-1, CORNING, NY, 14831, US

(21) Appl. No.: 12/220,784

(22) Filed: Jul. 28, 2008

Related U.S. Application Data
(63) Continuation of application No. PCT/EP2007/000692, filed on Jan. 26, 2007.

(30) Foreign Application Priority Data
Jan. 27, 2006 (DE) DE102006004010.4

(51) Int. Cl. G02B 6/02; B29D 11/00

(52) U.S. Cl. 385/100; 264/1.28

(57) ABSTRACT

An optical cable comprises a cable core (100) containing at least one optical transmission element (10a, 10b). The cable core (100) is free of filler composition. It contains, as optical transmission elements, a plurality of tight-buffered conductors (10a) or a plurality of bundle conductors (10b) which are arranged around a centrally arranged strain relief element (20). The cable core (100) is surrounded by a sleeve (200), which is extruded or pumped around the cable core. The sleeve layer (200) contains a plastic material with which swellable materials, for example acrylates, are mixed as filler. A cable sheath (300) is extruded around the sleeve layer (200). The swellable filler embedded in the sleeve layer brings about an increase in the volume of the sleeve layer (200) upon contact with water, whereby the cable core (100) is sealed against penetrating moisture.

### RELATED APPLICATIONS

This application is a continuation of International Application No. PCT/EP2007/000692, filed Jan. 26, 2007, which claims priority to German Application No. DE102006004010.4, filed Jan. 27, 2006, both applications being incorporated herein by reference.

### TECHNICAL FIELD

The application relates to an optical cable in which a cable core is surrounded by a sleeve. The application furthermore relates to a method for the production of an optical cable in which a cable core is surrounded by a sleeve.

### BACKGROUND

In optical cables, in particular in optical cables for underground and conduit applications, there is the risk that water can penetrate into the cable at an installation end or at damage locations. The penetration of water generally leads to an impairment of the transmission properties of the optical cable. The transmission properties are impaired particularly when water propagates within the cable in a longitudinal direction of optical transmission elements arranged in the cable core. Therefore, optical cables are generally embodied in longitudinally water-tight fashion.

In order to achieve the required longitudinal water-tightness, a large number of structural measures are implemented. The cable core of an optical cable, in which core the optical transmission elements are arranged, is filled with a filler composition, for example. The filler composition surrounds the individual optical transmission elements, such that no moisture can propagate along the optical transmission elements. Semidry cables contain no core filler composition. In the case of a semidry cable having bundle conductors as optical transmission elements, only the interior of the conductors is filled with a conductor filler composition. The optical waveguides in the interior of a conductor are thus protected against moisture. Since the conductor sleeves or the optical transmission elements are not surrounded by a core filler composition, by contrast, the cable core is generally surrounded by a swellable nonwoven. In the event of water penetrating into the cable core, the swellable nonwoven swells and thus seals the space between the individual optical transmission elements.

Besides the use of a swellable nonwoven for sealing the cable core, in addition swellable yarns are often arranged within the cable core. Like the swellable nonwovens, the swellable yarns thus also contain a swellable material which, upon contact with water, swells and thus seals the space within the cable core between the individual optical transmission elements.

In the case of cables free of filler composition, so-called dry cables, the sealing of the cable by core and conductor filler compositions is not permissible. In the case of dry cables, the longitudinal water-tightness is exclusively ensured by swellable nonwovens surrounding the cable core and thus the individual optical transmission elements, and by swellable yarns arranged within the cable core between the individual optical transmission elements.

Swellable nonwovens and also swellable yarns are processed on coils. When a swellable nonwoven is unwound from a coil, a strip-type swellable nonwoven is initially present. In order that the nonwoven strip encloses the cable core in sleeve-type fashion, it has to be formed into a sleeve. For this purpose, the nonwoven strip, having been unwound from the coil, is fed to a forming tube. Within the forming tube, the nonwoven strip is formed into a sleeve-type hose. This hose is subsequently arranged around the cable core or the optical transmission elements containing it.

Since the run length of a nonwoven strip on a coil is limited and the optical cable is generally significantly longer than the nonwoven strip wound up on the coil, the cable core of an optical cable is surrounded by a plurality of nonwoven strip sections formed in sleeve-type fashion. In this case, the individual nonwoven strip sections can overlap at their respective ends or can be separated from one another by a narrow gap.

At production-dictated connecting locations of two nonwoven strip sections, nodes or thickening locations often occur which are also outwardly visible particularly in the case of a thin skin of the cable sheath. Problems occur in the case of such an optical cable for example when the cable with its thickening locations is blown into an empty conduit. Furthermore, the nonwoven sleeve is significantly stiffer at an overlap location of two nonwoven strip sections than at other locations which has an adverse effect in the course of cable production. Also problematic is the occurrence of restoring forces that arise when the nonwoven strip formed into a sleeve leaves the forming tube. As a result of the restoring forces, the nonwoven sleeve tends toward bursting open again particularly at the overlap locations. Consequently, nodes, thick or thin locations also arise repeatedly in sections on account of said restoring forces along an optical cable in which the cable core is surrounded by a nonwoven sleeve. As a result of such points of discontinuity, the optical transmission properties are impaired and the further processing of the cable is made more difficult.

### BACKGROUND

One aspect of the present invention is addressed to an optical cable having longitudinal water-tightness and good processing properties. A further aspect of the present invention is a method of production of an optical cable with longitudinal water-tightness and good processing properties.

The optical cable may have a cable core having at least one optical transmission element containing at least one optical waveguide. The optical cable furthermore comprises a sleeve surrounding the cable core. The sleeve is formed from a plastic material into which is mixed a filler containing a swellable material which, upon contact with water, brings about an increase in the volume of the sleeve.

One development provides for the swellable material to contain an acrylate. The swellable material can also contain a salt composed of an acrylic acid.

In accordance with one embodiment of the optical cable, the filler contains magnesium hydroxide or aluminum hydroxide. The filler can also contain chalk.

According to a further feature of the optical cable, particles having a cavity within them are mixed into the plastic material. The particles can be embodied in spherical fashion. The particles preferably contain a silicate. They can also be embodied as tubes composed of carbon.

In another embodiment of the optical cable, the plastic material contains ethylene vinyl acetate. The plastic material can also contain polyvinyl chloride. It is also possible for the plastic material to contain a thermoplastic elastomer. The plastic material is preferably embodied as an oil-admixed or oil-extended thermoplastic elastomer. In accordance with a further feature of the optical cable, the sleeve is surrounded by a cable sheath. The cable core is preferably embodied as a cable core free of filler composition.

In accordance with a further embodiment of the optical cable, the cable core contains a swellable yarn comprising a swellable material which, upon contact with water, brings about an increase in volume.

In another embodiment of the optical cable, the optical cable comprises a strain relief element arranged centrally in the cable core. In this case, a plurality of the at least one optical transmission element are arranged around the strain relief element.

In accordance with another feature of the optical cable, the optical transmission element comprises an optical waveguide surrounded by a sleeve layer.

The method for producing the optical cable comprises the following steps: a polymer mixture is provided which comprises a plastic material into which is mixed a filler containing a swellable material which, upon contact with water, brings about an increase in volume. Furthermore, a cable core is provided which comprises at least one optical transmission element containing at least one optical waveguide. The polymer mixture is heated. The heated polymer mixture is applied around the cable core. The heated polymer mixture is cooled. A cable sheath is extruded around the polymer mixture.

One development of the method provides for applying the heated polymer mixture around the cable core by extruding the heated polymer mixture around the cable core. The heated polymer mixture can also be applied by pumping the heated polymer mixture around the cable core.

In accordance with a further feature of the method, the cable core is provided by arranging a plurality of the at least one optical transmission element around a strain relief element arranged centrally in the cable core.

The polymer mixture can be provided by dispersing an acrylate as swellable filler material into the plastic material. The polymer mixture can also be provided by dispersing chalk, aluminum hydroxide, magnesium hydroxide or particles containing silicates or carbon as further fillers into the plastic material.

A thermoplastic elastomer, ethylene vinyl acetate or polyvinyl chloride can be used as a plastic material. Preferably, an oil-admixed or oil-extended thermoplastic elastomer is used as the elastomer.

The invention is explained in more detail below with reference to Figures showing exemplary embodiments of the present invention.

### BRIEF DESCRIPTION OF THE DRAWING FIGURES

FIG. 1 shows a first embodiment of an optical cable in which a cable core of the optical cable is protected against the penetration of moisture.

FIG. 2 shows a second embodiment of an optical cable in which a cable core of the optical cable is protected against the penetration of moisture into the cable core.

FIG. 3 shows a production line for producing an optical cable that is protected against the propagation of moisture within the cable core.

### DETAILED DESCRIPTION

FIG. 1 shows a layer-stranded optical cable. The cable core 100 comprises a centrally arranged strain relief element 20, around which a plurality of optical transmission elements 10a are arranged. The optical transmission elements 10a are embodied as bundle conductors. They each comprise a plurality of optical waveguides 1 surrounded by a conductor sleeve 2. The cable core 100 is surrounded by a sleeve 200. A cable sheath 300 is extruded around the sleeve 200.

According to the invention, the sleeve 200 contains a plastic material in which is mixed a filler containing a swellable material which, upon contact with water, brings about an increase in the volume of the sleeve 200.

By way of example, acrylates or else salts composed of an acrylic acid are used as a suitable swellable material. These are dispersed as powder into a matrix polymer during a compounding process. The matrix polymer used is for example a base oil in which a fully synthetic rubber is dissolved. As a result, the base oil becomes able to take up fillers. Oil-admixed or oil-extended thermoplastic elastomers (TPE) can preferably be used as materials for the matrix polymer. However, it is also possible to use ethylene vinyl acetate (EVA) or polyvinyl chloride (PVC). Owing to the use of the materials stated, the sleeve 200 can easily be detached manually from the other cable components.

In order to support the longitudinal water-tightness, the cable core 100 furthermore contains swellable yarns 30. The latter, like the sleeve 200, likewise contain swellable substances which, upon the penetration of water, bring about an increase in the volume of the swellable yarns. Here, too, acrylates are appropriate as swellable materials. Upon the penetration of water, therefore, the sleeve 200 and also the swellable yarns 30 swell and seal the cable core 100, which is embodied as free of filler composition in the example in FIG. 1, against the penetration of water.

Besides its property of guaranteeing the longitudinal water-tightness of the cable core of the optical cable, the sleeve 200 additionally acts as a thermal barrier and as a separating layer between the cable core 100 and the cable sheath 300. In terms of its property as a thermal barrier, it prevents, for example, the optical transmission elements 10a from sticking to one another or to the cable sheath 300 during the extrusion of the cable sheath 300, on account of the high temperatures that occur in the process. The optical transmission properties of the cable would otherwise be significantly impaired as a result of the conductor sleeves 2 of the optical transmission elements 10a sticking in this way.

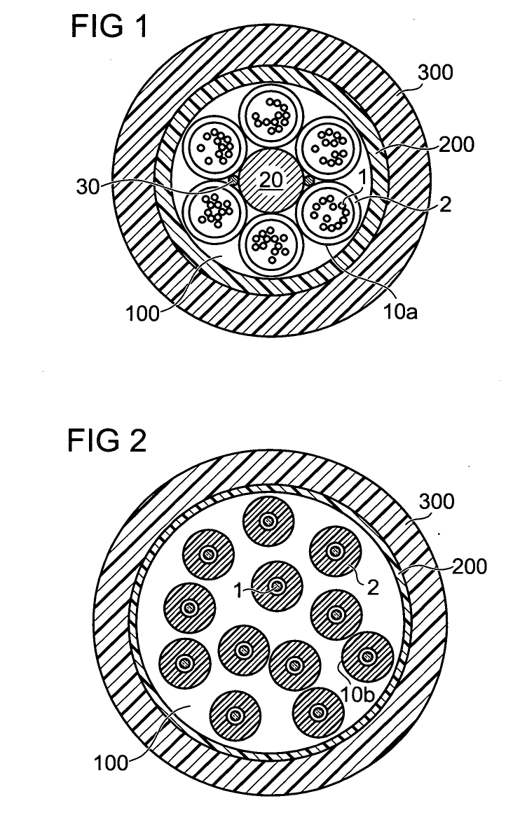

FIG. 2 shows a further embodiment of an optical cable in which a cable core 100 contains a plurality of optical transmission elements 10b. The optical transmission elements 10b are embodied as tight-buffered conductors in the example in FIG. 2. A tight-buffered conductor comprises an optical waveguide core 1 surrounded by a compact sleeve layer 2. According to the invention, the cable core 100 is surrounded by a sleeve 200 formed by a plastic material into which is embedded as filler a material which increases its volume upon contact with water. Here, too, the acrylates already mentioned are appropriate as suitable filler materials. Polyvinyl chloride (PVC), ethylene vinyl acetate (EVA) or thermoplastic elastomers (TPE) are preferably used as the matrix polymer into which fillers are embedded. In particular oil-admixed or oil-extended thermoplastic elastomers are used in this case. These are particularly well suited to being filled with a filler.

The use of a sleeve 200 in the exemplary embodiments in FIGS. 1 and 2 composed of the stated plastic materials into which a swellable filler is embedded enables the sleeve 200 to be extruded such that it is very thin and highly elastic. Besides the possibility of arranging the sleeve 200 around the cable core 100 in the context of an extrusion process, there is also the possibility of applying the filled plastic material around the cable core 100 by pumping. This is attributable to the low viscosity of the material, for example when using an oil-extended thermoplastic elastomer.

In the embodiments shown in FIGS. 1 and 2, even further filler materials can also be used in addition to the use of fillers having swellable properties. By way of example, as a further filler chalk can be mixed with the matrix polymer. This reduces the oil content of the base oil, whereby the strength and stability of the sleeve 200 are increased.

If the sleeve 200 is additionally intended to have flame-retardant properties, as a further filler magnesium hydroxide or aluminum hydroxide, for example, can be mixed with the matrix polymer. Magnesium hydroxide and aluminum hydroxide are among the active fillers. The flame retardancy of matrix materials filled with metal hydroxides is attributable to the fact that metal hydroxides cleave water in the case of a fire.

Examples of further fillers are nanoparticles. Phyllosilicates that are mixed into the matrix polymer in finely dispersed fashion can be used as nanoparticles. So-called nanotubes can also be used as nanoparticles. These are a multilayer construction of thin graphite layers comprising layers of up to ten atoms. Nanotubes can be produced with an internal diameter of 5 nm and an external diameter of up to 10 nm. The length is on average 1000 to 1500 nm. The surface resistance of the material can be reduced by using such nanoparticles as fillers for the matrix polymer of the sleeve 200. Furthermore, abrasion during production can be reduced by the use of nanoparticles as fillers. Nanoparticles as fillers furthermore serve as a processing aid during cable production by means of which the flowability of the matrix polymer can be improved.

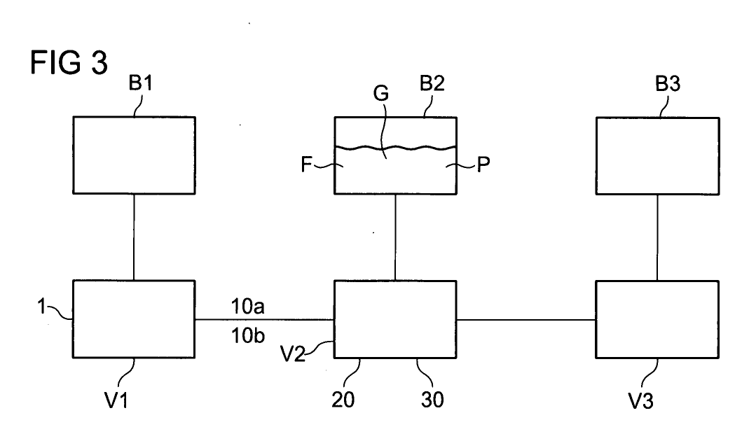

FIG. 3 shows a production line for producing the cable arrangements indicated in FIGS. 1 and 2. An optical waveguide 1 is fed to a processing unit V1. The processing unit V1 is connected to a container B1 containing a polymer melt. The polymer melt is fed to the processing unit V1. In the processing unit V1, the polymer melt is extruded as a conductor sleeve 2 around the optical waveguides 1. In this case, the processing unit V1 can be embodied in such a way that either bundle conductors or tight-buffered conductors are produced as optical transmission elements. In the case of a bundle conductor, a plurality of optical waveguides 1 are surrounded by the conductor sleeve composed of the polymer melt, whereas the polymer melt surrounds the optical waveguides 1 compactly after cooling in the case of forming a tight-buffered conductor.

An optical transmission element in the form of a bundle or tight-buffered conductor is subsequently fed to a processing unit V2. Furthermore, a central element 20 and swellable yarns 30 are fed to the processing unit V2. The processing unit V2 is connected to a container B2. The container B2 contains a polymer mixture G composed of a matrix polymer P and a filler F. Preferably, ethylene vinyl acetate, polyvinyl chloride or an oil-admixed or oil-extended thermoplastic elastomer is used as the matrix polymer P. A swellable substance, such as an acrylate, for example, is used as the filler F. The container B2 can additionally contain further fillers such as chalk, magnesium hydroxide, aluminum hydroxide or nanoparticles.

The polymer mixture G is heated in the container B2, and fed to the processing unit V2. Furthermore, a strain relief element 20 and swellable yarns 30 are fed to the processing unit V2. In the processing unit V2, the polymer melt P is extruded as a sleeve 200 around the cable core 100 of the optical cable. In the case of the production of a layer-stranded cable comprising bundle conductors, the cable core contains the strain relief element 20, the bundle conductors 10a and the swellable yarns 30. In the case of the production of a cable comprising tight-buffered conductors, the cable core, as shown in FIG. 2, contains the tight-buffered conductors 10b.

Since the polymer melt in the container B2 has a very low viscosity particularly when using an oil-extended thermoplastic elastomer, the polymer melt P can also be pumped as a sleeve around the cable core. Consequently, the extrusion process can also be replaced by a pumping process.

In the case of the production of an optical cable according to FIG. 1, the processing unit V2 is connected to a processing unit V3. The processing unit V3 is in turn connected to a container B3, which contains a polymer melt used for forming the cable sheath 300. After cooling of the extruded or pumped sleeve material of the sleeve 200, the cable sheath 300 is extruded around the sleeve 200 in the processing unit V3.

In contrast to the use of a nonwoven sleeve, according to the invention a continuously extrudable or pumpable layer 200 is arranged as a sleeve around the cable core 100. The extrusion or the pumping of such a melt and the shaping of the melt to form a layer prevent thickening locations, such as arise when using a nonwoven sleeve on account of the overlapping of individual nonwoven strip sections, along the cable core. Furthermore, the production process is improved since coil changes or coil run-outs are avoided. Furthermore, bonding locations at which two nonwoven strip sections were previously stuck to one another are avoided along the cable sheath. Owing to the use of an extrudable or pumpable layer as a sleeve around the cable core, the optical transmission properties of the optical cable are improved, whereas nonwoven sleeves and their overlap locations previously always represented a disturbance of the conductor geometry, which led to an impairment of the optical transmission properties.

### LIST OF REFERENCE SYMBOLS

1 Optical waveguide
2 Conductor sleeve
10 Optical transmission element
20 Strain relief element
30 Swellable yarn
100 Cable core
200 Sleeve
300 Cable sheath
V Processing unit
B Container
G Polymer mixture
P Matrix polymer
F Filler

What is claimed is:

1. An optical cable comprising:
a cable core having at least one optical transmission element containing at least one optical waveguide; and
a sleeve surrounding the cable core,
wherein the sleeve is formed from a plastic material into which is mixed a filler containing a swellable material which, upon contact with water, brings about an increase in the volume of the sleeve.

2. The optical cable of claim 1, wherein the swellable material contains an acrylate.

3. The optical cable of claim 1, wherein the swellable material contains a salt composed of an acrylic acid.

4. The optical cable of claim 1, wherein the filler contains magnesium hydroxide or aluminum hydroxide.

5. The optical cable of claim 1, wherein the filler contains chalk.

6. The optical cable of claim 1, wherein particles having a cavity within them are mixed into the plastic material.

7. The optical cable of claim 6, wherein the particles are spherical.

8. The optical cable of claim 6, wherein the particles contain a silicate.

9. The optical cable of claim 6, wherein the particles are tubes comprised of carbon.

10. The optical cable of claim 1, wherein the plastic material contains ethylene vinyl acetate.

11. The optical cable of claim 1, wherein the plastic material contains polyvinyl chloride.

12. The optical cable of claim 1, wherein the plastic material contains a thermoplastic elastomer.

13. The optical cable of claim 12, wherein the plastic material comprises an oil-admixed or oil-extended thermoplastic elastomer.

14. The optical cable of claim 1, wherein the sleeve is surrounded by a cable sheath.

15. The optical cable of claim 1, wherein the cable core is free of filler composition.

16. The optical cable of claim 1, wherein the cable core contains a swellable yarn comprising a swellable material which, upon contact with water, brings about an increase in volume.

17. The optical cable of claim 1, further comprising a strain relief element arranged centrally in the cable core, wherein a plurality of the at least one optical transmission element are arranged around the strain relief element.

18. The optical cable of claim 1, wherein the optical transmission element comprises an optical waveguide surrounded by a sleeve layer.

19. A method for the production of an optical cable, comprising:
providing a polymer mixture comprising a plastic material into which is mixed a filler containing a swellable material which, upon contact with water, brings about an increase in volume;
providing a cable core having at least one optical transmission element containing at least one optical waveguide;
heating the polymer mixture;
applying the heated polymer mixture around the cable core;
cooling the heated polymer mixture; and
extruding a cable sheath around the polymer mixture.

20. The method of claim 19, further comprising applying the heated polymer mixture around the cable core by extruding the heated polymer mixture around the cable core.

21. The method of claim 19, further comprising applying the heated polymer mixture around the cable core by pumping the heated polymer mixture around the cable core.

22. The method of claim 19, further comprising providing the cable core by arranging a plurality of the at least one optical transmission element around a strain relief element arranged centrally in the cable core.

23. The method of claim 19, further comprising providing the polymer mixture by dispersing an acrylate into the plastic material.

24. The method of claim 19, further comprising providing the polymer mixture by dispersing chalk, aluminum hydroxide, magnesium hydroxide or particles containing silicates or carbon as further fillers into the plastic material.

25. The method of claim 19, wherein a thermoplastic elastomer, ethylene vinyl acetate or polyvinyl chloride is used as plastic material.

26. The method of claim 25, wherein an oil-admixed or oil-extended thermoplastic elastomer is used as the elastomer.
